(19) United States
(12) Patent Application Publication
(10) Pub. No.: US 2007/0086626 A1
(43) Pub. Date: Apr. 19, 2007

(54) Individual identity authentication systems

(75) Inventors: Roberto Mariani, Singapore (SG); Han Xu, Singapore (SG); Yuanxin Zhang, Singapore (SG)

Correspondence Address: CHRISTIE, PARKER & HALE, LLP, PO BOX 7068, PASADENA, CA, 91109-7068, US

(73) Assignee: XID TECHNOLOGIES PTE LTD, Singapore (SG)

(21) Appl. No.: 10/575,130

(22) PCT Filed: Oct. 8, 2003
(86) PCT No.: PCT/SG03/00239

§ 371 Date: Apr. 7, 2006

(51) Int. Cl. G06K 9/00

(52) U.S. Cl. 382/115

(57) ABSTRACT

A single image from a camera (14) is captured of an individual (40) seeking entry through a door held by a door latch (24). An image processor (16) looks for and locates a tag (42) worn by the individual (40) in the image and reads an identification (ID) code from the tag (42). A comparator (20) compares this ID code with ID codes in an identification database (22) to find a match. Once a match of ID codes is found, the image processor (16) looks for and locates a face (44) of the individual (40) in the image and extracts facial features from the face (44). The comparator (20) compares the extracted facial features with facial features associated with the matched ID code, from the identification database (22), to find a match. Once there is a match of facial features, the door latch (24) is released.

### FIELD OF THE INVENTION

The present invention relates to individual identity authentication systems, in particular visual authentication systems that compare data from a single picture of an individual with data in a database to authenticate the individual's identity.

### BACKGROUND OF THE INVENTION

In the past, access to certain areas, whether buildings, rooms or other places was generally controlled by a human guard standing outside the restricted area, or through the use of physical keys, lock combinations, swipe cards and/or access codes. The problem with guards is that they are expensive, potentially corruptible and generally inefficient. The problem with physical keys, swipe cards and other forms of physical access devices is that they can be damaged, lost, forgotten, stolen, given to others or copied. The problem with lock combinations and access codes is that they too can be stolen or told to others. There is no guarantee that the person using the keys or codes etc is a person authorised to use them.

To overcome these problems it has recently been suggested that access be allowed based on some form of biometrics scan. Thus there may be a fingerprint scanner, an iris scanner, a voice recorder or a camera to compare a fingerprint, iris picture, voice recording or picture of a face with potentially corresponding information held in a database. If a match is found, then access is allowed. The advantage of this is that one's fingerprint, iris, voice and face are always with one and that they are very difficult to copy.

However, the software behind many biometrics access systems is imperfect. The systems often have to allow for variations in the input data for the same person. For instance, with facial recognition the system may need to cope with changes to hairstyle or colour, change to spectacles, the presence of bags under a person's eyes from a bad night's sleep, or a different angle between the face and camera. Voice recognition needs to cope with someone having a cold.

Such problems are less likely with fingerprint or iris recognition; however, those suffer from other disadvantages. For fingerprint recognition, the user has to have an empty hand and touch a scanner for a certain duration. Emptying one's hand can be inconvenient and the fingerprint scanner can soon get dirty. If the people using the scanner are factory workers or otherwise prone to dirty hands, their fingerprints may be unreadable and the fingerprint scanner may get dirty very quickly. For iris recognition, the user has to remove any spectacles and stand close to a camera. Again, this can be inconvenient, especially as the camera may be quite low to accommodate the shortest user.

To overcome some of the problems, particularly with facial recognition, some systems require something more, for example in terms of an access code, a radio frequency identification (RFID) tag, a swipe card, a flash card or the like, to confirm that the person is authorised. However, as before, such cards can be damaged, lost, forgotten or stolen. They also tend to be quite expensive. Thus these systems are not widely used in conferences or other short term events.

The additional access code, RFID tag, swipe card or other systems also add to the costs. Quite often the two sets of apparatus come from different suppliers and there may be problems linking them together and they cost more to maintain.

Some approaches to determining identification involve object detection, for instance as are described in:

U.S. Pat. No. 4,972,499, issued on 20 Nov. 1990, to Kurosawa, which relates to pattern recognition apparatus;

U.S. Pat. No. 6,038,337, issued on 14 Mar. 2000, to Lawrence et al, which describes a method and apparatus for object recognition;

[Bunke et Bluhler, 1993] Bunke, H. et Bluhler, U. (1993). Application of Approximate String Matching to 2D Shape Recognition. Pattern Recognition, 26: 1797-1812; and

[Luo et Dinstein, 1995] Luo, H., et Dinstein, I (1995). Using Directional Mathematical Morphology for Separation of Character Strings from Text/Graphics Image. In Shape, Structure and Pattern Recognition—Post-proceedings of IAPR Workshop on Syntactic and Structural Pattern Recognition, Nahariya (Israel), pages 372-381. World Scientific.

Some approaches to determining identification involve reading systems for reading parts of images, for instance as are described in:

[Antoine, 1989] Antoine, D. (1989). A Technical Document Understanding System Based on a priori Knowledge. In Proceedings of the 6^{th} Scandinavian Conference on Image Analysis, Oulu (Finland), pages 843-846;

[De Jesus, 1995] De Jesus, E. O. (1995). ECIR—An Electronic Circuit Images Recognizeer. In Proceedings of IAPR International Workshop on Graphics Recognition, Penn State Scaticon (USA), pages 252-261;

[Bhattacharjee et Monagan, 1994] Bhattacharjee, S. et Monagan, G. (1994). Recognition of Cartographic Symbols. In Proceedings of IAPR Workshop on Machine Vision Applications, Kawasaki, Japan, pages 226-229; and

[Fletcher et Kasturi, 1988] Fletcher, L. et Kasturi, R. (1988). A Robust Algorithm for Text String Separation from Mixed Text/Graphics Images. IEEE Transactions on PAMI, 10(6):910-918.

Object detection and reading are described in:

[O'Gorman et Kasturi, 1995] O'Gorman, L. et Kasturi, R. (1995). Document Image Analysis—pp 101-105 IEEE Computer Society Press, Los Alamitos, Calif.;

[Fu, 1974] Fu, K. (1974). Syntactic Methods in Pattern Recognition. Volume 112. Academic Press, New York; and

[Fu, 1982] Fu, K. (1982). Syntactic Pattern Recognition and Applications. Prentice Hall, New York

Known approaches to facial recognition include those described in:

U.S. Pat. No. 5,450,504, issued on 12 Sep. 1995, to Calia, which describes a method for finding a most likely matching of a target facial image in a data base of facial images;

U.S. Pat. No. 5,991,429, issued on 23 Nov. 1999, to Coffin et al, which describes a facial recognition system for security access and identification;

U.S. Pat. No. 6,072,894, issued on 6 Jun. 2000, to Payne, which describes a method for biometric face recognition for applicant screening;

U.S. Pat. No. 6,108,437, issued on 22 Aug. 2000, to Lin, which describes a face recognition apparatus, method, system and computer readable medium thereof; and

U.S. Pat. No. 6,600,830, issued on 29 Jul. 2003 to Lin et al, which describes a method for locating a face and extracting facial features.

### SUMMARY OF THE INVENTION

According to one aspect of the present invention, there is provided apparatus for authenticating the identity of a person. The apparatus comprises image processing means for determining an identification code from within an image and for determining face data of a face within said same image.

According to another aspect of the present invention, there is provided a method of authenticating the identity of a person. The method comprises determining an identification code from within an image and determining face data of a face within said same image.

According to again another aspect of the present invention, there is provided a computer program product having a computer usable medium having a computer readable program code means embodied therein for authenticating the identity of a person. The computer readable program code means comprises computer readable program code image processing means for determining an identification code from within an image and for determining face data of a face within said same image.

The invention provides an exemplary embodiment in which a single image from a camera is captured of an individual seeking entry through a door held by a door latch. An image processor looks for and locates a tag worn by the individual in the image and reads an identification (ID) code from the tag. A comparator compares this ID code with ID codes in an identification database to find a match. Once a match of ID codes is found, the image processor looks for and locates a face of the individual in the image and extracts facial features from the face. The comparator compares the extracted facial features with facial features associated with the matched ID code, from the identification database, to find a match. Once there is a match of facial features, the door latch is released.

### INTRODUCTION TO THE DRAWINGS

The present invention is further described by way of non-limitative exemplary embodiment, with reference to the accompanying drawings, in which:

FIG. 1 is a schematic drawing showing the use of an authentication system according to an embodiment of the invention;

FIG. 2 is a flowchart for use in understanding a first part of the exemplary operation of the system of FIG. 1;

FIG. 3 is a flowchart for use in understanding a second part of the exemplary operation of the system of FIG. 1;

FIG. 4 is a view of a screen showing various images during the authentication process; and

FIG. 5 is a flowchart relating to the enrolment process.

### DETAILED DESCRIPTION

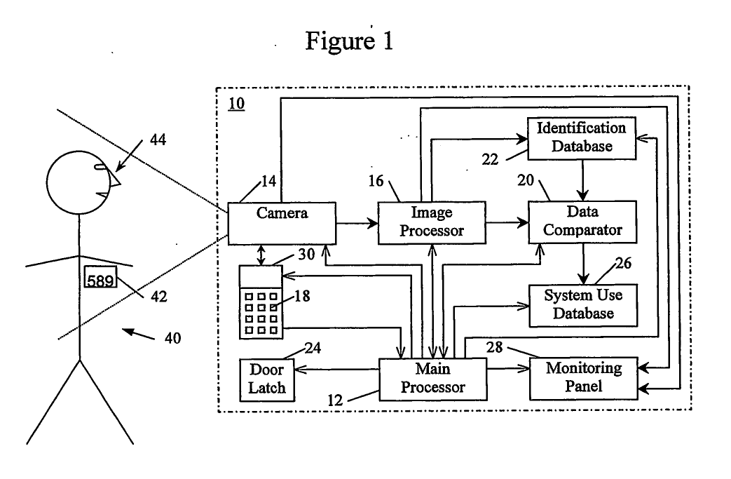

FIG. 1 is a schematic drawing showing the use of apparatus, in the form of an authentication system 10 according to a preferred embodiment.

The authentication system 10 is controlled by processing means, here a main processor 12. Within the authentication system 10, imaging means in the form of a video camera 14 provides a video image signal to an image processor 16, which receives the signal. The image processor 16 operates to capture an image from the video image signal, when an operation switch on a keypad 18 is used. The image processor 16 is able to perform four operations on such a captured image:
(i) locate a tag;
(ii) tag reading and identification code extraction;
(iii) locate a face; and
(iv) facial feature extraction.
   A data comparator 20 is connected to the image processor 16 and to an identification database 22. The identification database 22 contains records of identification codes and associated facial images. The data comparator 20 is able to compare the extracted identification code from the image processor 16 with the identification codes in the identification database 22 and, where there is a match, to compare the extracted facial features from the image processor 16 with the facial features associated with the matching identification code in the identification database 22. A door latch 24 is connected to the data comparator 20, and unlatches a door when it receives an unlatch signal from the data comparator 20. A system use database 26 is also connected to the data comparator 20 and receives the results of its comparisons. Additionally a monitoring panel 28, for instance in a security room is connected to the image processor 16, so that it can receive a copy of the captured image and is also connected to the camera 14 so that it can receive a continuous video image signal. The main processor 12 is connected to and controls the camera 14, the image processor 16, the data comparator 20, the identification database 22, the door latch 24, the system use database 26, the monitoring panel 28 and a display 30. The main processor 12 is connected to and receives input from the image processor 16, the keypad 18, the data comparator 20 and the monitoring panel 28. The camera 14 is also connected to the display 30 to allow it to display the current video image as feedback. The main processor 12 also sends the display other information to display to the person 40.

The system 10 is for use in authenticating the identity of a person 40, who is wearing a tag 42, based on an identification (ID) code on the tag, and recognition of the person's face 44. It is this individual who, in this embodiment, operates the operation switch on the keypad 18 to allow him to pass through a door held shut by the door latch 24.

The system 10 is also used in enrolling people and entering identification codes and associated facial images into the identification database 22, for which purpose the image processor 16 is also connected to the identification database 22.

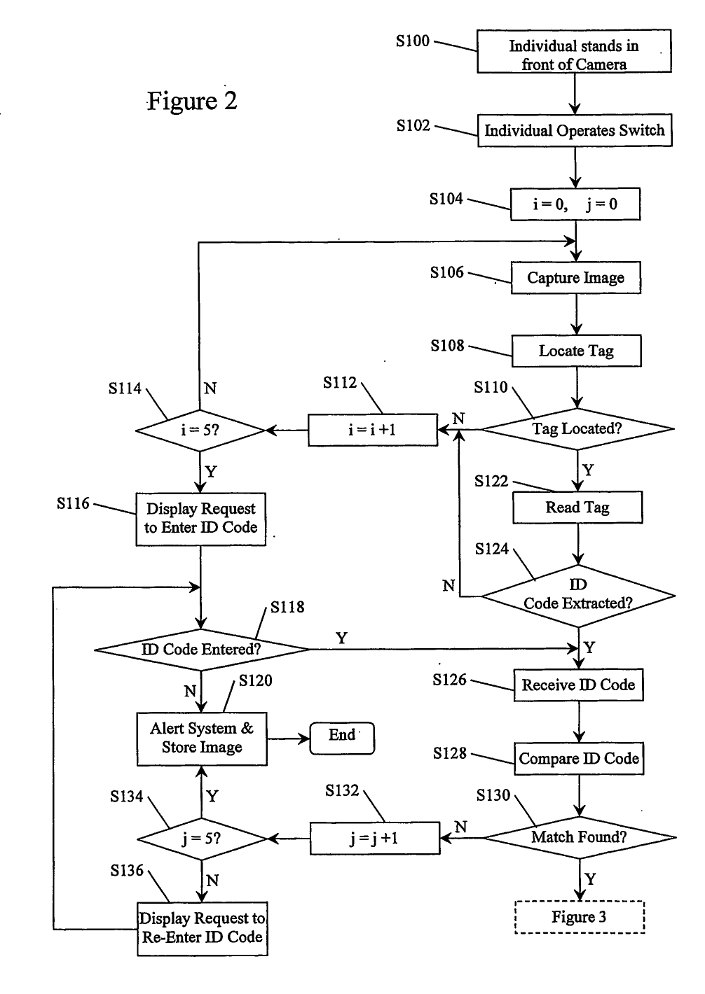

FIG. 2 is a flowchart for use in understanding a first part of the exemplary operation of the system 10 of FIG. 1. In particular it relates to obtaining and matching an identification (ID) code. In summary, the system 10 automatically detects, at a distance, the presence of a tag 42 in an image of a person 40, and decrypts the content of the tag 42, to recover an ID code. Once the ID code has been recovered, the system 10 determines if the ID code is in the identification database 22 (and thereby valid for access for the area for which entry is sought). If the ID code is in the identification database 22, the person's face 44 in the image is detected, the facial features are extracted and a check is made to see if the extracted facial features match those features in the identification database 22 which correspond to the valid ID code. If they do match, then access is allowed.

At step S100 an individual 40, wishing to gain access to an area behind a locked door, stands in front of the camera 14. The individual 40 operates the operation switch on the keypad 18 at step S102, which starts the specific operation of the authentication system 10.

Operating the operation switch on the keypad 18 at step S102 causes the processor 12 to initiate a first counter i=0 and a second counter j=0, at step S104. At step S106 the image processor 16 receives the image signal from the camera 12 and captures an image from within the current image signal from the camera 14. At step S108, the image processor 16 analyses the image to locate a tag 42 within the image. The processor 12, at step S110, determines if a tag has been located. If a tag has not been located, the first counter i is incremented by 1, at step S112. The processor determines if the first counter i=5, at step S114. If the first counter i is not 5, the operation returns to step S106. If the first counter i=5 at step S114, this means that the system has tried unsuccessfully to locate a tag five times. The processor 12 at step S116 causes the display 30 to display a message that the individual 40 should enter his identification code by way of the keypad 18. The processor determines at step S118 if an identification code is entered by way of the keypad 18. If no code is entered, then at step S120, the processor 12 causes the current captured image to be sent to the system use database 26, together with other information such as the time, date, location and any ID code entered, and to the monitoring panel 28 and itself sends an alarm signal to the monitoring panel 28. After which the operation ends.

If step S110 determines that a tag has been located, the image processor 16 reads the tag and decrypts the information read to extract an identification (ID) code, in step S122 (the ID code may be in plain text or may, for instance, be encrypted within an image). The processor 12 determines at step S124 if an ID code has been extracted. If no ID code has been extracted, the operation goes back to step S112, so that the image can be re-captured or the individual 40 can be asked to enter his code on the keypad 18. If step S124 determines that an ID code has been extracted, the extracted ID code is sent to the data comparator 20, which receives it at step S126. The ID code may also be received by the comparator 20 at step S126 from the keypad 18, if it is determined as having been entered at step S118.

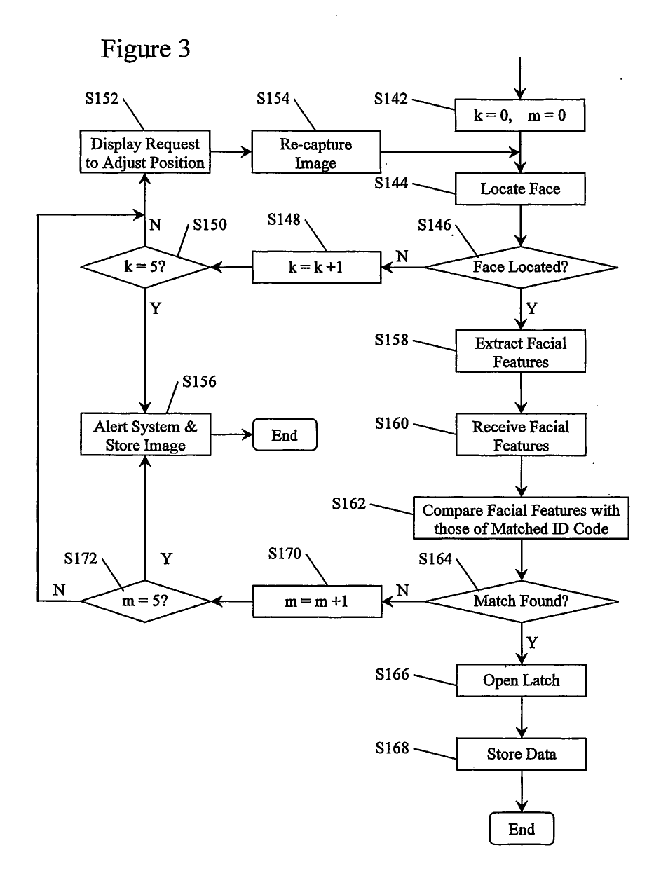

The received ID code is compared, by the data comparator 20, with the ID codes contained in the identification database 22, at step S128. The processor 12, at step S130, determines if a match has been found in step S128. If step S130 determines that a match has been found then the operation proceeds to the process described below with reference to FIG. 3. If step S130 determines that no match has been found at step S128, the second counter j is incremented by 1 at step S132. At step S134 the processor 12 determines if j=5. If j does not equal 5, then at step S136 the processor 12 causes the display 30 to display a message that the individual 40 should re-enter his ID code by way of the keypad 18. The operation then goes back to step S118, to determine if the ID code is re-entered to allow further comparison if it is or to end the process if it is not.

FIG. 3 is a flowchart for use in understanding a second part of the exemplary operation of the system 10 of FIG. 1. In particular it relates to extracting and matching facial features.

The process of the flowchart of FIG. 3 starts if a match is found at step S130 of FIG. 2, that is if the ID code read from the tag or entered by the person 40 matches an ID code stored in the identification database 22.

At step 142, the main processor 12 initiates a third counter k=0 and a fourth counter m=0. The image processor 16 analyses the same captured image as was captured in step S106 of FIG. 2, at step S144, to locate a face within the captured image. Where tags are typically worn at a certain place, such as around the neck, on a breast pocket or at a particular point of clothing (for instance as they are part of the clothing), the identified tag position, from step S108 in FIG. 2 can be used as a reference point to help locate the face. The main processor 12, at step S146, determines if a face has been located. If a face has not been located, the third counter k is incremented by 1, at step S148. The main processor 12 determines if the third counter k=5, at step S150. If the third counter k is not 5, the operation passes to step S152, where the display 18 displays a request for the person 40 to adjust his position. At S154 a further image is captured by the camera 14. After this the process reverts to step S144. If the third counter k=5 at step S150, this means that the system has tried unsuccessfully to locate a face five times. The processor 12 causes the current captured image to be sent to the system use database 26, together with other information such as the time, date, location and any ID code entered, and to the monitoring panel 28 and itself sends an alarm signal to the monitoring panel 28, at step S156. After which the operation ends.

If step S146 determines that a face has been located, the image processor 16 extracts facial features from the captured image, at step S158. The extracted facial features are sent to the data comparator 20, which receives them at step S160.

At step S162 the facial features are compared, by the data comparator 20, with the facial features contained in the identification database 22, that are associated with the ID code matched at step S128 of FIG. 2. The comparison uses a face matching algorithm between the retrieved image from the database and the captured image, to determine if the faces are of the same person. The processor 12, at step S164, determines if a match has been found in step S162. If step S164 determines that a match has been found then the door latch 24 is opened at step S166 and information relating to the successful operation (time, date, location, ID code and current counts of counters i, j, k and m) is written to the system use database 26 at step S168, after which the operation ends.

If step S164 determines that no match has been found, the fourth counter m is incremented by 1 at step S170. At step S172 the processor 12 determines if the fourth counter m=5. If the fourth counter m does not equal 5, then the process reverts to step S152, where the display 18 displays a request for the person 40 to adjust his position, and the process proceeds as indicated above from that step. If the fourth counter m=5 at step S172, this means that the system has tried unsuccessfully to match five different sets of facial features without success, at the process reverts to step S156, which operates as described above.

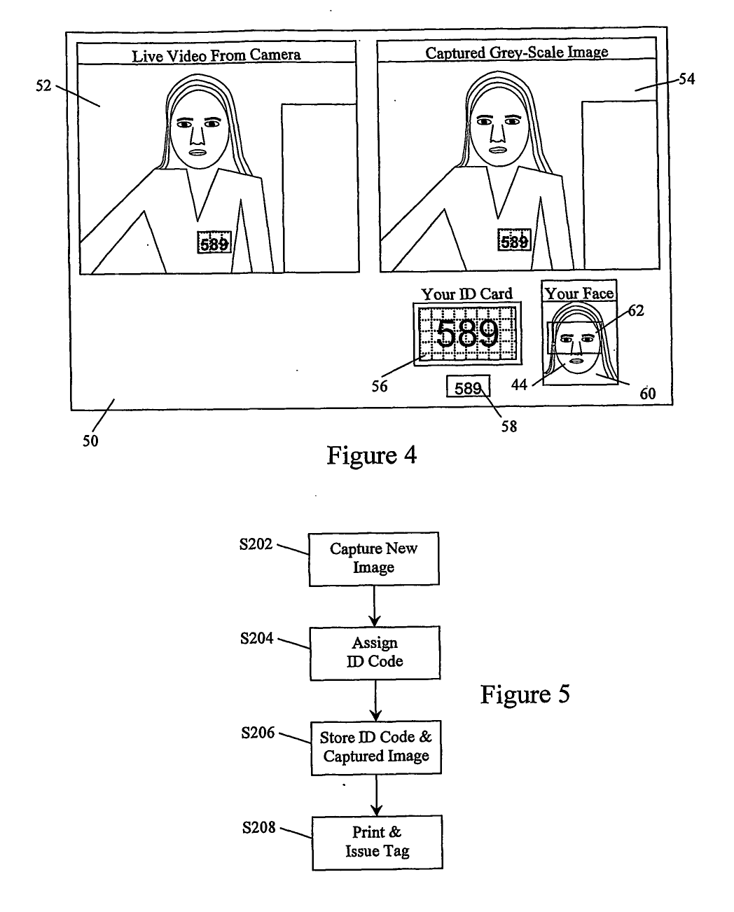

FIG. 4 is an example of a view 50 presented to the person 40 at the display 30 during the authentication process. This is the view 50 after the tag 42 has been located, the ID code has been read, the face 42 has been located and the facial features are being or have been extracted. The continuous video signal is displayed in a first window 52. The captured image being analysed is displayed in a second window 54. The located tag is displayed in a third window 56, with the extracted and read ID code, in this case “589”, displayed in an ID code area 58 below the third window 56. A fourth window 60 displays the detected face 44. A rectangle 62 within the fourth window 60 indicates the area of the face 44 being analysed for facial features extraction.

In the two processes described with reference to FIGS. 2 and 3, there are four counters i, j, k and m, each with a maximum count of 5. The purpose of these counters is to allow for some imperfections in the system, for instance if the tag or face cannot be located in a particular image, the tag cannot be read, the extracted facial features do not match those associated with a particular ID code in the identification database or the user inputs the wrong ID code. According to how many iterations of any particular sub-routine the system operator is prepared to allow, the maximum count can change, and different counters could have different maxima. For instance the maximum for counter j may be set lower than that for counter i, since most people prefer a system to be less tolerant to the numbers ID codes entered, than to the numbers of attempts at getting an ID code entered. Alternatively, it may be decided that there is no room for second chances at facial recognition, particularly if the room being accessed is very sensitive. Thus a negative result at step S164 may lead straight to step S156. This is equivalent to step S172 determining if the fourth counter m=1.

The current counts of the four counters i, j, k and m may be saved in the system use database whenever the operation ends, as they may provide useful information as to how well the system is working.

The identification database in the above-described system 10 contains facial feature data associated with specific ID codes. This data may be in its original form, in terms of a photograph, or as extracted facial features, or both. Where a photograph is stored, it will man that new identification photographs will not needed when the facial recognition software is updated. However, if it is only the photograph that is stored, it will require facial feature extraction every time its associated ID code is entered. This can be provided by the image processor 14 and may occur as soon as a valid ID code is entered, to speed up the process. The identification database is easily maintained, allowing the addition and removal of people by software.

Where the ID code is encrypted, it may circumvent security to allow the person 40 to enter his ID code by a keypad 18. In some embodiments this option may therefore not exist or be more closely controlled. Another alternative may therefore be to have a separate camera or scanner for the tag and for step S116 of FIG. 2 to be the display of a request for the person to put his tag in front of that camera or scanner. Step S118 would need amending accordingly, with the next step being step S122, rather than step S126. Alternatively again, there may be no extra camera or scanner. Step S116 of FIG. 2 may be the result of a negative determination at step S114, and be changed to a request for the person to put his tag closer to the camera. A new closer image would be captured for tag locating and reading, but the original image might be used for face locating and facial feature extraction. A positive determination from step S114 would then lead straight to step S120.

The operation of the above system 10 assumes that if a person's ID code is in the identification database 22, he will be allowed access to the restricted area. In a further alternative, there may be an access code also associated with each identification entry in the identification database 22. Entry to the restricted area then not only requires a valid ID code but also a valid access code. Thus if a person approaches a level 1 door and has a level 1 access code associated with his ID code in the identification database 22, the level 1 door will open. However, if he approaches a level 2 door, the system will determine that his level 1 access code is not sufficient and will refuse access. Such a system may be useful where there is more than one restricted area and different groups of people are allowed access to different areas. It may even be useful if there is only one restricted area as it may provide information as to which known people have been trying to access the area.

In the above embodiment, the identification database includes a list of individual ID codes and operates on the basis of a direct comparison between the extracted ID code and the ID codes in the list. In a further embodiment, there is no separate list of ID codes in the identification database. Instead, the ID code is verified based on an internal property of itself. For instance it may be a requirement that the code satisfies a specific polynomial function, at the equivalent of step S130.

For this system, the tag does not need to be an electronic card, or RF card. It can simply be printed information to be read in the visible (or near visible) spectrum. It can be printed (e.g. using ink, embossing, burning, sewing etc) on paper, plastic, metal, fabric, skin (or any other material) and can be carried in the hand or around the neck, pinned, stuck to or sewn into or to clothing or printed directly onto clothing. Typical information carried on such a tag might be particulars of the person represented by text (e.g. the name of the person and rank), other information in text (e.g. a plain or encrypted ID code), or images (e.g. a barcode, a pattern of colours, a company logo). If a printed tag is lost, forgotten or damaged, the system administrator can immediately issue a new one, at minimal cost, using only a printer and computer. Further, where a tag is printed on a factory shirt, or on a doctor's coat, it does not constrain the doctor or the factory worker by requiring him to carry his tag in his hand or around his neck constantly. Further, the tag does not need to be a distinct portion of what the person is carrying or wearing; it could be an area amongst many that carries sufficient information to read an ID code. For instance, if the ID code is contained within a pattern printed all over a garment such as a shirt, the tag is then any portion of that garment of sufficient size that carries enough of the pattern to read the ID code.

The above system as described does require some contact between the person and the system, in that the person has to initiate the process by operating a switch on the keypad. However, alternative embodiments can be more truly contactless, where initiation can be based on the output from a weight sensor or infra-red detector or by constantly monitoring images from the video camera for the presence of a person, or there may be other ways used.

In the above-described embodiment, the monitoring panel is only sent information when there is an unsuccessful attempt at entry. Alternatively, the monitoring panel may be provided constantly with data from the authentication system, such as the feed from the camera 14, the captured image from the image processor 16, any entered or extracted ID code etc.

The tag reading process within the authentication system 10 has two parts:
(a) a tag localisation part, which falls in the general category of object detection; and
(b) a tag reading part, which falls in the general category of structured document reading.
   Both object detection and structured document reading are well-known technologies.

An exemplary approach to object recognition to locate the tag in step S108 uses pattern detection within the image captured at step S106. The detection is parametric and depends on the shape of the tag and/or a colour scheme associated with the tag. For instance, if the tag is rectangular with a black rectangular frame on a white background, those patterns may be what are sought.

Any suitable object detection system can be used in this exemplary embodiment, for instance that described in the prior art mentioned in the background of the invention section earlier, e.g. in U.S. Pat. No. 4,972,499.

An exemplary approach to structured document reading to read the tag in step S122 uses optical character recognition (OCR) on the area of the image captured at step S106 which is determined as being the tag in step S108. The image area corresponding to the tag is transformed to normalise it to a predetermined size. A search is conducted on the image area corresponding to the tag, to look for characters to be recognised within predefined areas of the tag. Each character image is binarised to an adapted threshold. Each character image is compared with reference character images in a pre-stored list of potential character images (digits and/or letters). Once the individual character recognition is completed, the complete tag ID character string is reconstructed using the recognised characters.

Tag reading within step S122 may also involve some form of decryption or internal verification to validate the ID code. This can be used both to help in reading the ID code and in determining attempts at fraudulent access. For example, if all valid ID codes have the format “xyz” and all valid ID codes satisfy the function 7x−2y−3z=0, then only certain numbers between 000 and 999 would satisfy both criteria.

Help in Reading the ID Code:

If the number on a tag is “307”, then this does satisfy the function 7x−2y−3z=0 and so could be valid. However, during the reading of the tag, the identification of x could result in it being be viewed as a 3 or an 8; the identification of y may result in it being viewed as a 0 or an 8; and the identification of 7 may result in it being viewed as a 7 or a 1. There are therefore eight different possible readings: 307, 807, 387, 887, 301, 801, 381, 881, but of these only 307 is possibly valid. The system, assuming that the card would be valid, would then be quite certain that 307 is the correct ID code.

Determining Attempts at Fraudulent Access

On the other hand, if someone came along with a tag number “317”, then this does not satisfy the function 7x−2y−3z=0 and so is invalid. Even allowing for inaccurate reading, where the 3 may be read as a 3 or an 8, the 1 may be read as a 1 or a 7 and the 7 may be read as a 7 or a 1, there is no combination of any of those in the xyz order that would satisfy 7x−2y−3z=0. Thus the ID Code would always re rejected. However, if someone came along with the tag number “801”, which does not satisfy the function 7x−2y−3z=0 and so is invalid, it might still be read as “307” and deemed valid. However, it might not then pass the facial recognition match. Therefore entry (or whatever is being guarded) would still be refused.

The requirement to verify an internal polynomial Function (x,y,z)=0 increases the robustness of the identification dynamically. Various polynomial functions might be used for various applications and/or countries and/or times, making it more difficult to deceive the system.

Whilst the above approach relies just on the number itself and a specific function for validation, validation could rely on two or more numbers on the tag and a function relating them, or on a number or numbers on the tag and an image on the tag and a function relating them. These may serve for validation (as above) or for decryption of one or more of the numbers (or an image).

Any suitable document reading system can be used in this exemplary embodiment, for instance that described in the prior art mentioned in the background of the invention section earlier, e.g. in the document identified as Antoine, 1989.

Exemplary tags for use in the above described exemplary embodiment of an authentication system are designed to be easily detected in an image and easily read, using predefined geometry and/or predefined patterns and/or predefined colours. For instance a suitable tag could be a rectangular card, with a black outer frame and a white inner area, the ID code printed in black within the white inner area.

If obtaining the ID code is to involve some form of decryption, the tags may also contain predefined images, with or without text. With both text and images, the ID code is decrypted using the images and the text simultaneously, and the decrypted code may also be required to verify an internal polynomial function to be validated, at the equivalent to step S130.

The face recognition system within the authentication system 10 has two parts:
(c) a face detection part; and
(d) a face matching part, that performs feature extraction from the captured face and matches these features against corresponding features extracted from the images in the identification database.

For example, an exemplary operation of the face recognition system localises the face, for instance by way of edge detection, pattern recognition or second-chance region growing. The face region is normalised to a predetermined size. The eyes are detected within the normalised image and features are extracted around the eyes, nose and mouth. A voting circuit compares the extracted features with extracted features from the identification database.

Any suitable face detection process can be used in this exemplary embodiment, for instance that described in the prior art mentioned in the background of the invention section earlier, e.g. in U.S. Pat. No. 6,108,437 or U.S. Pat. No. 6,600,830.

There may, as a further option, be a third part between the first two parts: a face synthesis part, able to generate a multitude of facial appearances from a single image, by simulating the appearance of this face in varying lighting conditions, varying poses, varying distances from the camera, with glasses or not, and with facial hair, moustaches, etc. This acts to normalise the results and allows the extraction part of the face detection process to provide more consistent results between storing the information in the identification database and generating extracted facial features to compare with those in the identification database.

An alternative to this is to synthesise different conditions during the registration of a person's face, that is before it is stored in the identification database. Thus a multitude of face prototypes are synthesised automatically, by creating artificial lighting conditions, artificial face morphing and by modelling the errors of a face location system, especially in the eyes detection process. These face prototypes represent the possible appearances of the initial face, under various lighting conditions, various expressions and various face direction, and under various errors of the face location system. For each face, a set of faces is obtained that spans the possible appearances the face may have.

Having generated this multitude of face prototypes, classical data analysis can be applied, like dimensionality reduction (principal components analysis), feature extraction, automatic clustering, self-organising maps etc. The design of a face recognition system based on these face prototypes can also be achieved. Classical face recognition systems based on face templates and/or feature vectors may be applied, and they may also use these face clusters for finding matches.

FIG. 5 is a flowchart relating to the enrolment process, when a person is to be added to the identification database 22. At step S202 an image of the new person is captured. This may be from the camera 14 or from another source, that is another camera, a scanner or a file imported into the system. An ID code is assigned to the person at step S204 and stored in the identification database 22 together with the captured image at step S206. A tag is printed and issued to the new person at step S208. The whole process may take less than five minutes.

As mentioned above, the identification database 22 can store facial feature information as well as or instead of a picture of the person. The relevant step to obtain these features would occur between steps S202 and S206 above.

The step of assigning an ID code to the person could simply involve using his name, choosing the next number in a sequence of numbers or something else relatively non-complex. A more complex alternative is to extract the facial features from the picture, find the most similar person in the database by automatic face matching, and select an ID code as dissimilar to the ID code for the near matching person as possible. Additional information, such as eye and hair colour and other distinctive features can also be stored in the identification data and checked during facial matching, for improved security. This may be particularly useful if identical twins are involved. When colour is an aspect of the data in the identification database to be checked, the captured image should be in colour. Otherwise, it may be a greyscale image.

In the above-described embodiment, if a valid ID code is not entered no face locating nor facial feature extraction occurs. In a further alternative embodiment, whilst access may still be denied in such cases, face locating and facial feature extraction would still occur, as would facial matching on all the images in the identification database. That way it might be possible to see quickly who is always forgetting his tag or ID code. If the identification database also contains images of specific people, such as ex-staff, industrial spies, criminals or other wanted people or terrorists, then such matching may note the presence of such people and cause a more precipitate reaction than might otherwise occur.

In the main exemplary embodiment, tag identification comes before facial recognition. In a further alternative embodiment, these two processes are reversed, that is the process of FIG. 3 comes after step S106 of FIG. 2, but before the rest of FIG. 2. Thus steps S166 and S168 and the succeeding end step of FIG. 3 would come directly after a positive result from step S130 of FIG. 2 and would be replaced with a direction to step S108 of FIG. 2 (some further changes might also be required, such as providing a step after a negative result from step S114 to capture further images if the tag could not be located from the existing image). In such an alternative embodiment, the determined location of the face could be used as a reference position for determining the position of the tag.

In yet a further alternative embodiment, tag detection, ID code reading and ID code matching happens in parallel with face detection, facial feature extraction and face matching.

The described embodiment or modified versions of it may readily find uses in factory, plant, laboratory or military camp, secure premises access control, time and attendance tracking, prisoner authentication (is the right person in the right cell), driver authentication (is an accepted person trying to drive the car), access to exhibitions, conferences, games, flights or other restricted access events.

The embodied system provides a complete two factor, human authentication method, which operates at a distance, and uses only computer vision technology. It has a simple hardware infrastructure, at one basic level requiring only a camera and computer. It does not depend on means such as RFID tags, magnetic cards or smartcards that are traditionally used to carry information about the person. The use of the exemplary system allows the elimination of card readers and their maintenance. It itself is easy to maintain, it relies on only a single camera, it is contactless, it is easy to install for short events like exhibitions or conferences and it has low costs associated with card issuance or replacement.

The above described system is operable as a robust, fully automatic computer vision system based on just a single camera. It simultaneously detects the face of a person and a tag carried or worn by that same person. Based on both of the tag and face from a single image, the system certifies the validity of the identity of the person, using tag reading technology and face recognition technology. The system and process are low cost, do not rely on a fusion of heterogeneous hardware like smartcards and RFID tags, and do not lead to the recycling of used tags and cards (which tends to happen when cards are expensive but can lead to confusion). The administrator can easily remove a person, disallow a person, change the data on a person, and print new the tags and arrange specific databases for specific events.

The above described exemplary embodiment is described with reference to unlatching a door. Other embodiments may be used for other purposes, such as accessing computer files, using certain facilities, logging in or confirming attendance, etc.

In the above description, components of the system are described with reference to their functions. Individual functions or groups of them can be viewed as modules. The components and in particular their functionality, can be implemented in either hardware or software. In the software sense, a module is a process, program, or portion thereof, that usually performs a particular function or related functions. In the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the system can also be implemented as a combination of hardware and software modules.

Further, whilst certain components are shown as being separate in FIG. 1, in other embodiments, the various functions may be carried out in a single component. For instance image processing and data comparisons may be carried out together, possibly within the processing means. Likewise the identification database may be stored together with the system use database. Other embodiments may use other combinations.

A method, an apparatus, and a computer program product for authentication the identity of an individual. It will be apparent to one skilled in the art, however, that the present invention may be practised without these specific details. In other instances, well-known features are not described in detail so as not to obscure the present invention.

The embodiments of the invention are able to do so using several variants in implementation. From the above description of specific embodiments, it will be apparent to those skilled in the art that modifications/changes can be made without departing from the scope and spirit of the invention. In addition, the general principles defined herein may be applied to other embodiments and applications without moving away from the scope and spirit of the invention. Consequently, the present invention is not intended to be limited to the embodiments shown, but is to be accorded the widest scope consistent with the principles and featured disclosed herein.

1. Apparatus for authenticating the identity of a person, comprising:
image processing means for determining an identification code from within an image and for determining face data of a face within the same image.

2. Apparatus according to claim 1, wherein the image processing means is operable to read said identification code from printed data within said image.

3. Apparatus according to claim 1 or 2, wherein the image processing means is operable to locate a tag within said image.

4. Apparatus according to claim 3, wherein the image processing means is operable to determine said identification code from said tag within said image.

5. Apparatus according to claim 3 or 4, wherein the image processing means is operable to locate said tag based on the location of the face within said image.

6. Apparatus according to any one of claims 3 to 5, wherein the image processing means is operable to determine said identification code from said tag when the tag is a specific area of any one of: paper, plastic, metal, fabric, an item of clothing and skin.

7. Apparatus according to any one of the preceding claims, wherein the image processing means is operable to locate said face from within said image.

8. Apparatus according to claim 7 when dependent on any one of claims 3 to 6, wherein the image processing means is operable to locate said face based on the location of the tag within the image.

9. Apparatus according to any one of the preceding claims, wherein the image processing means is operable to extract facial features from said face.

10. Apparatus according to any one of the preceding claims, further comprising identification code comparator means for matching the determined identification code with a stored identification code in an identification code database.

11. Apparatus according to any one of the preceding claims, further comprising face comparator means for matching the determined face data with stored face data in a face data database.

12. Apparatus according to claims 10 and 11, wherein the face data database comprises the identification code database.

13. Apparatus according to claim 12 or according to claims 10 and 11, wherein the face data database comprises the identification code database.

14. Apparatus according to claim 12 or 13 or according to claims 10 and 11, wherein the face data in the face data database is associated with specific identification codes in the identification code database.

15. Apparatus according to claim 14, further comprising authentication means to confirm identity authentication when the face comparator means matches the determined face data with stored face data in the face data database and the identification code comparator means matches the determined identification code with the stored identification code associated with the matched stored face data.

16. Apparatus according to any one of claims 10 and 12 to 15 or according to claim 11 when dependent on claim 10, further comprising stopping means for preventing determination of the face data if no match is made by the identification code comparator means.

17. Apparatus according to any one of claims 11 to 15, further comprising stopping means for preventing determination of the identification code if no match is made by the face data comparator means.

18. Apparatus according to any one of the preceding claims, further comprising imaging means for providing said image to said image processing means.

19. A method of authenticating the identity of a person, comprising:
determining an identification code from within an image; and
determining face data of a face within the same image.

20. A method according to claim 19, wherein determining an identification code comprises reading said identification code from printed data within said image.

21. A method according to claim 19 or 20, further comprising locating a tag within said image.

22. A method according to claim 21, wherein determining an identification code comprises determining said identification code from said tag within said image.

23. A method according to claim 21 or 22, wherein locating a tag comprises locating said tag based on the location of the face within said image.

24. A method according to any one of claims 21 to 23, wherein determining an identification code comprises determining said identification code from said tag when the tag is a specific area of any one of: paper, plastic, metal, fabric, an item of clothing and skin.

25. A method according to any one of claims 21 to 24, wherein said tag is part of a garment worn by the person in the image.

26. A method according to any one of claims 19 to 25, further comprising locating said face from within said image.

27. A method according to claim 26 when dependent on any one of claims 21 to 25, wherein locating said face comprises locating said face based on the location of the tag within the image.

28. A method according to any one of claims 19 to 27, further comprising extracting facial features from said face.

29. A method according to any one of claims 19 to 28, further comprising matching the determined identification code with a stored identification code.

30. A method according to any one of claims 19 to 29, further comprising matching the determined face data with stored face data.

31. A method according to claim 29 and 30, wherein the stored face data is associated with specific stored identification codes.

32. A method according to claim 31, further comprising confirming identity authentication when the determined face data matches stored face data and the determined identification code matches the stored identification code associated with the matched stored face data.

33. A method according to any one of claims 29, 31 and 32 or according to claim 30 when dependent on claim 29, wherein determining the face data is not completed unless the determined identification code is matched with a stored identification code.

34. A method according to claim 33, wherein determining the face data is not started unless the determined identification code is matched with a stored identification code.

35. A method according to any one of claims 30 to 32, wherein determining the identification code is not completed unless the determined face data is matched with stored face data.

36. A method according to claim 35, wherein determining the identification code is not started unless the determined face data is matched with stored face data.

37. A method according to any one of claims 19 to 36, further comprising:
generating said image; and
providing said image for identification code determination and face data determination.

38. A computer program product having a computer usable medium having a computer readable program code means embodied therein for authenticating the identity of a person, comprising:
computer readable program code image processing means for determining an identification code from within an image and for determining face data of a face within the same image.

39. A computer program product according to claim 38, wherein the image processing means is operable to read said identification code from printed data within said image.

40. A computer program product according to claim 38 or 39, wherein the image processing means is operable to locate a tag within said image.

41. A computer program product according to claim 40, wherein the image processing means is operable to determine said identification code from said tag within said image.

42. A computer program product according to claim 40 or 41, wherein the image processing means is operable to locate said tag based on the location of the face within said image.

43. A computer program product according to any one of claims 40 to 42, wherein the image processing means is operable to determine said identification code from said tag when the tag is a specific area of any one of: paper, plastic, metal, fabric, an item of clothing and skin.

44. A computer program product according to any one of claims 38 to 43, wherein the image processing means is operable to locate said face from within said image.

45. A computer program product according to claim 44 when dependent on any one of claims 40 to 43, wherein the image processing means is operable to locate said face based on the location of the tag within the image.

46. A computer program product according to any one of claims 38 to 45, wherein the image processing means is operable to extract facial features from said face.

47. A computer program product according to any one of claims 38 to 46, further comprising computer readable program code identification code comparator means for matching the determined identification code with a stored identification code in an identification code database.

48. A computer program product according to any one of claims 38 to 47, further comprising computer readable program code face comparator means for matching the determined face data with stored face data in a face data database.

49. A computer program product according to claims 47 and 48, wherein the face data in the face data database is associated with specific identification codes in the identification code database.

50. A computer program product according to claim 49, further comprising computer readable program code authentication means to confirm identity authentication when the face comparator means matches the determined face data with stored face data in the face data database and the identification code comparator means matches the determined identification code with the stored identification code associated with the matched stored face data.

51. A computer program product according to any one of claims 47, 49 and 50 or according to claim 48 when dependent on claim 47, further comprising computer readable program code stopping means for preventing determination of the face data if no match is made by the identification code comparator means.

52. A computer program product according to any one of claims 48 to 50, further comprising computer readable program code stopping means for preventing determination of the identification code if no match is made by the face data comparator means.

53. A computer program product according to any one of claims 38 to 52, further comprising computer readable program code receiving means for receiving said image for processing by said image processing means.
